(19) United States
(12) Patent Application Publication
(10) Pub. No.: US 2009/0206278 A1
(43) Pub. Date: Aug. 20, 2009

(54) PHOTO-OPTICAL-ELECTRONIC GAS, PRESSURE AND TEMPERATURE SENSOR

(75) Inventor: Marvine Hamner, Frederick, MD (US)

Correspondence Address: VENABLE LLP, P.O. BOX 34385, WASHINGTON, DC, 20043-9998, US

(73) Assignee: Leatech, LLC, Frederick, MD (US)

(21) Appl. No.: 12/300,298

(22) PCT Filed: May 8, 2007
(86) PCT No.: PCT/US07/11026

§ 371 Date: Nov. 10, 2008

Related U.S. Application Data
(60) Provisional application No. 60/798,807, filed on May 8, 2006.

(51) Int. Cl. G01N 21/64

(52) U.S. Cl. 250/459.1; 250/458.1; 250/216

(57) ABSTRACT

A sensor according to the invention includes a surface having a sensing material that is responsive to a change in an environmental condition when illuminated. An illumination source is positioned to illuminate the surface. A receiver is positioned to receive light emanating from the surface; and a detector detects a change in light received at the receiver.

### BACKGROUND OF THE INVENTION

### Field of the Invention

The present invention relates generally to optical sensors. More particularly, the invention relates to an optical sensor for detecting environmental changes using optical properties of a sensing surface.

### SUMMARY OF THE INVENTION

In summary, a sensor according to the invention includes a surface having a sensing material that is responsive to a change in an environmental condition when illuminated. An illumination source is positioned to illuminate the surface. A receiver is positioned to receive light emanating from the surface; and a detector detects a change in light received at the receiver.

The detector can be a comparator, and the system can include a variable reference voltage at the detector, a positive feedback loop, and/or an indicator, such as a colored light, to indicate a change in light received at the receiver. The surface can further include a coating that includes comprises the sensing material. The environmental condition can be, for example temperature, pressure and atmospheric composition, such as a change in atmospheric oxygen content.

Changes in the sensor can be an emission spectrum or intensity of the sensing material changes in response to the change in the environmental condition when illuminated. Exemplary sensing materials include a dye in a polymer matrix, a dye incorporated into a polymer material, and/or a polymer that comprises a pair detector compounds form a fluorescence resonance energy transfer pair or are capable of forming an exciplex. The polymer can be a polyurethane, a polyacrylate or a silicone.

The invention is also a method for detecting a change in an environmental condition that includes illuminating a surface that includes comprising a sensing material, receiving the light emitted from the surface when the surface is illuminated, detecting a change in the light emitted from the surface when the environmental condition changes; and outputting a signal to an indicator. The light emitted from the sensing material when the surface is illuminated changes in response to a change in the environmental condition and the illuminating, receiving and detecting are carried out by an integrated system.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 is a schematic representation of a sensor according to the present invention; and

FIG. 2 is a schematic circuit diagram of an exemplary embodiment of the present invention.

FIG. 3 is a schematic diagram of another exemplary embodiment of the invention.

### DETAILED DESCRIPTION OF THE PRESENT INVENTION

Embodiments of the invention are discussed in detail below. In describing embodiments, specific terminology is employed for the sake of clarity. However, the invention is not intended to be limited to the specific terminology so selected. Preferred embodiments of the invention are discussed in detail below. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

Sensors are commonly used to detect environmental changes at a location. Environmental changes can include, for example, changes in the temperature, pressure, and atmospheric composition. The location at which changes may be detected can be very small or very localized. For example, it may be necessary to place a sensor in a confined area where environmental conditions are important, such as a test area where the local environment may affect performance of a mechanical, structural or electrical device or surface. Sensors may also be useful to detect hazardous substances, for example gases, in a relative rapid and localized manner in order to prevent hazardous situations.

The present invention is directed to an optical sensor useful in a number of situations described above. According to the invention as illustrated schematically in FIG. 1, a surface 1 includes a sensing material 2. The sensing material 2 can be, for example, a dye, chromophore, indicator or other probe, and may be incorporated in a coating. In the illustrated embodiment, the sensing material 2 is incorporated into a coating that is coated on the surface 1. In this case, illumination of the surface includes illumination of the coating on the surface and thus the sensing material in the coating. However, it will be understood by persons skilled in the art that the sensing material could be incorporated into the surface itself, so that there is no separate coating on the surface. The surface 1 containing the sensing material 2 is illuminated with incident light 3. Light 4 is emitted from the illuminated sensing material 2. Several mechanisms are possible for the emission of light 4 from the surface. For example, the light emitted may be reflected light. Alternatively, the sensing material may be such that it absorbs and re-emits light fluoresces upon illumination in which case the emitted light is from the sensing material. Exemplary mechanism for this type of light emission include fluorescence and phosphorescence.

Importantly, the chemical or physical properties of the sensing material 2 is such that there is a change in the light emission in response to some environmental condition in the area of the sensor. The change in light emission could be manifested in several ways. For example, in the case of reflected light, the reflectivity of the surface may change resulting in a change in, for example in intensity or wavelength, of the reflected light in response to the change in environmental condition. In the case of fluorescence or phosphorescence, the intensity or wavelength of the light emitted by fluorescence or phosphorescence may change. Sensing materials useful in the present invention having properties that change in response to changing environmental conditions are known in the art.

For example, pressure sensitive paints are known in which the fluorescence of a paint component, i.e. the sensing material, changes in response to changes in the oxygen content of the atmosphere surrounding the material. Traditional pressure sensitive paints consist of a host matrix in which one of a variety of chromophores is encapsulated as the sensing material. The host matrix is often a polymeric material such as polydimethylsiloxane (PDMS), but other materials such as sol-gels can be used. Typical chromophores include, for example, platinum octaethylporphyrin (PtOEP) and ruthenium-based complexes. The functionality of these pressure sensitive paints depends on the dynamic quenching of the chromophore's luminescent emission by oxygen. Dynamic quenching is accomplished by diffusion of oxygen into the host matrix throughout the “paint” to the chromophore(s). One example of a prior art application requiring the diffusion of oxygen is U.S. Pat. No. 5,965,632 to Gouterman which teaches the use of a pressure sensitive paint incorporating an acrylic and fluoroarcrylic polymer binder. A pressure sensing dye is dissolved or dispersed in the polymer matrix. The dyes fluoresce in the presence of molecular oxygen. Similarly, in a prior non-related application to Kelley et al., the pressure sensitive material used has a host polymer and a fluorescent compound attached to the host polymer. The host polymer has a “rubber like” characteristic rather than a rubbery elastomer. In the system disclosed by Kelley et al., polystyrene is used in place of a polyurethane and rubberized polymethacrylate because it does not contain oxygen.

In another example, the pressure sensitive paint is a polymer containing exciplex forming moieties or moieties that create a fluorescent resonance energy transfer (FRET) complex. Such systems are disclosed in U.S. Pat. No. 7,176,272 to Hamner et al. and U.S. Patent Application Publication No. 2005/0288475 to Hamner. The pressure sensitive paints disclosed in those references include a polymer backbone, such as polyurethane, polyacrylate or silicon. An exciplex (excited state complex) is the result of the formation of a charge transfer complex between an excited state fluorophore and a quencher. In one example of the system disclosed in those references, exciplex forming compounds, for example dimethylaniline (quencher) and anthracene (fluorophore), are each modified for incorporation into the polymer backbone. For example, the exciplex forming compounds can be modified to include a diol functionality, which may be either directly on the compound, e.g. ring substituted anthracene and/or dimethylaniline, or a diol containing chain may be attached to the compound. The diol containing exciplex forming compounds can then be copolymerized with other diols or polyols, such as polypropylene glycol, in the formation of a polyurethane.

In other embodiments, a FRET system is used. In FRET, transfer of excited state energy takes place from an initially excited donor to an acceptor. An exemplary embodiment of a donor-acceptor systems in FRET is Fluorescein (donor) and Rhodamine B (acceptor). In this system as well, the compounds are modified for incorporation into a polymer backbone. For example, Fluorescein and Rhodamine B can be modified or derivatized to form fluorescein dimethacrylate, and Methacryloxyethyl thiocarbamoyl rhodamine B, respectively, for incorporation into a polyacrylate backbone. In either the exciplex or FRET systems of the Hamner published applications, the emission spectrum of the illuminated material changes upon changes in pressure. The changes are due to changes in the spatial relationship, i.e. the distance between, the fluorophore/quencher or donor/acceptor pairs upon compression or relaxation of the polymer backbone that holds the pair of moieties in a space apart relationship. That is, as the distance between the pair of molecules changes, for example becomes closer due to polymer compression at increased pressures, the fluorescence and/or absorption spectrum changes.

Other examples of sensing materials that exhibit changes in spectral properties in response to changes in environmental conditions include temperature sensitive materials. Traditionally these are mixtures comprised of temperature sensitive chromophores dissolved in polymer solutions. Temperature sensitive chromophores typically used include, but are not limited to Europium (III) Thenoyltrifl (EuTTA); Tris(2,2′-bipyridyl) dichloro-Ruthenium(II) hexahydrate or tris-(2,2′-bipyridine) ruthenium(II) chloride hexahydrate) (Ru(bpy)); Ruthenium(II) bis(2,2:6,2-terpyridine) (Ru(trpy)); Pyronin B; Pyronin Y; Platinum Octaethyl Porphyrin (PtOEP); and Chromium doped Yttrium Aluminum Garnet (Cr:YAG). These temperature sensitive systems may also show sensitivity to changes in pressure. For these systems, the intensity of emission generally decreases at increased temperatures. Hamner (U.S. Patent Application Publication No. 2005/0288475) discloses coating formulations having both pressure and temperature sensitive properties.

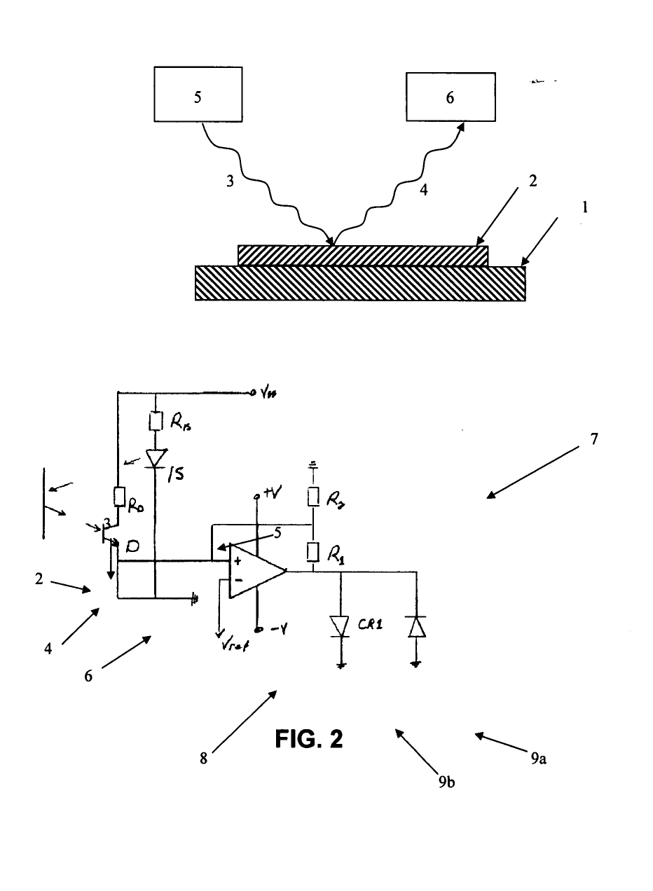

According to embodiments of the present invention, as illustrated in FIG. 1, an illumination source 5 illuminates the sensing material 2 on the surface 1. In an exemplary embodiment, the illumination source is one or more light emitting diodes (LED). The illumination source is selected to emit light at a wavelength that is suitable to the system being used for sensing. Emitted light 4 is then received by a receiver 6 for detection as described in more detail below with reference to FIG. 2. Exemplary receivers include, for example, photodiodes, photodiode arrays, and phototransistors. Appropriate optics, e.g. amplifiers, filters and/or lenses, can be added if required; for example for operation over longer distances, or due to required wavelengths for illumination or detection.

FIG. 2 illustrates an exemplary configuration of the circuitry 7 for a sensor according to the present invention. According to FIG. 2, an illumination source 5, in this diagram in the form of a diode, generates light which illuminates a sensing material 2 on a surface. Emitted light 4 from the surface is received by a receiver, for example a phototransistor as illustrated, to allow passage of a voltage. Data from the receiver is sent to a detector. In some embodiments, the receiver and the detector may be the same piece of equipment. The detector in the illustrated circuit, which may be in the form of a comparator 8, detects changes in the voltage relative to a reference voltage V_{ref}. The comparator 8 detects the voltage from the phototransistor, which triggers an indicator, such as a visual indicator, for example a diode, and/or an audible indicator, for example an alarm, or other indicator. In an exemplary embodiment, the indicator is a LED or pair of LEDs. For example, in a system used to detect a hazardous substances, a light such as a green light can be used as a “system safe” indicator 9b, and a red light can be used as a “system failure” indicator 9a. As long as there is no change in voltage from the receiver 6 to the detector 8, the system safe indicator 9b is illuminated. When a change in an environmental condition occurs, the emitted light 4 from the sensing material changes and results in a change in voltage from the receiver 6, which is detected by the comparator 8, causing illumination of the system failure light 9a.

In another exemplary embodiment of the invention, the environmental change is measured quantitatively. According to this embodiment, the comparator 8 is able to variably detect changes in response to changing intensity or wavelength of the emitted light 4. The change, for example, in intensity, can be related quantitatively to the change in environmental condition. The change and ability to measure the change quantitatively can be affected by the nature of the sensing material, the nature of the receiver and environmental change being measured. Preferably, voltage from the receiver 6 varies in a regular manner depending on the degree, i.e. the amount, of the environmental change. In an alternative embodiment, the receiver 6 can be a photodiode array, each with an associated comparator 8. The system would then have a means for detecting signals from the various comparators for output to a device, such as a computer, for comparison and output of data. The regular manner in which the intensity changes may be, for example, linear or exponential, depending on the sensing material and the environmental change being measured. The comparator 8 can be calibrated for variations in voltage from the receiver 6. The detector circuitry can include the ability to detect and indicate variable changes in accordance with a calibration curve. Signal intensity can be indicated in several ways including, a digital readout, and analog read out, for example a needle and gauge, or a series of lights.

It is desirable to keep the potential difference into the operational amplifier as small as possible. To achieve this, the circuit allows for the possibility of a variable reference voltage. A variable reference voltage can be set to coincide with the dark voltage for the detector to create a system that will respond to a lower input signal, i.e. in this case lower emission intensities.

The system further allows for the use of feedback to increase the overall response time, if desired. In embodiments of the invention, positive feedback may be employed. In one example of a positive feedback arrangement, the output of the operational amplifier may be connected to the positive input of the operational amplifier. This arrangement quickly translates a small change in the operational amplifier output into a much bigger output, that is, the magnitude of the output is positively increased. Positive feedback may increase the speed of detection by enhancing the system's ability to detect very small changes. Additionally, positive feedback may be used help mitigate erroneous signals due to noise. A Schmidt Trigger may be employed for this purpose. For example, when a noise signal causes a sensor to fluctuate between safe and failure, positive feedback may be used to limit the oscillation. Two thresholds may be established, one positive and one negative. Positive feedback may be used to drive the system beyond one of the thresholds whereby the system would not oscillate unless the output crosses the other threshold.

The present invention can also include a “negative feedback” mechanism. In a negative feedback, when the sensor determines that an undesirable condition is present, rather than, or in addition to, turning on a “system failure” indicator, the sensor electronics trigger a device to rectify the undesirable condition. For example, if the condition is an undesirable atmospheric component, the device could trigger a fan to move the atmosphere away from the device. Rather than amplifying an undesired response, as in positive feedback, the triggered device acts to alleviate the undesired condition. When the undesired condition is alleviated, as sensed by the sensor, the triggered device is turned off and the indicator, if present, returns to its original state, or the “system safe” indicator is activated. Alternatively, as will be appreciated, some device in a system being monitored could be “on” in a normal condition and, when an undesirable condition is reached, turned “off” by negative feedback mechanism until the system returns to its normal condition.

An exemplary use of a sensor according to the present invention is in the detection of a change in the atmospheric composition around a sensor. In a particular example, the present sensor can be used to detect the depletion of oxygen or the increased presence of a gas such as nitrogen or hydrogen. One commercially important development in transportation is the use of fuel cells, for example in automobiles. Fuel cells utilize hydrogen, an explosive gas, to generate electricity. At least some manufactures are designing automobiles that have the fuel cell in the passenger compartment, often encased within a secondary structure. The leak of hydrogen gas in the passenger compartment of an automobile can be detrimental. At least in theory, the leak of hydrogen gas could cause asphyxiation or an atmosphere prone to ignition or explosion. Thus, the early and sensitive detection of a hydrogen leak is essential, and mechanisms for its mitigation can be beneficial. Current systems for the detection of hydrogen in such a situation are not practical.

According to this use of the present invention, a sensing material is placed near the hydrogen fuel cell, for example within the secondary structure containing the fuel cell. In one exemplary embodiment of this system, the sensing surface includes a material that has a fluorescence that is quenched by oxygen. Thus, as long as the atmosphere surrounding the sensor, i.e. the atmosphere within the secondary structure, contains oxygen, there is no emission and the environment is considered “safe,” and the system safe indicator is illuminated. If a leak occurs in the hydrogen fuel cell, the atmosphere within the secondary structure housing the cell becomes more hydrogen rich and less oxygen rich. This atmosphere would diffuse into the sensing material, lowering the effective concentration of oxygen. As the oxygen concentration decreases, the fluorescence of the sensing material increases, the receiver receives illumination and the detector senses a voltage change. This voltage changes results in the illumination of the system failure indicator.

In an exemplary embodiment of a hydrogen sensor according to the invention, the sensing material can be octaethylporphyrin. The octaethylporphyrin can be contained within a polydimethylsiloxane coating. The coating can also include silica gel and polyurethane, and may be applied as a solution in a suitable solvent.

A hydrogen sensor according to the present invention can include additional components. For example, the sensor system could include a collection system as part of the secondary structure. The collection system can be, for example, a “boot” or cover made of a suitable material, for example rubber. The collection system can encase the entire fuel cell, or can encompass only those parts that are prone to leaks, such as seams, valves and fittings. The sensor itself is a relatively small module that can be simply snapped into place in the overall collection system, and thus easily replaced during routine maintenance. It may also be advantageous to include a mechanical or microelectromechanical system (MEMS) to circulate the atmosphere over the sensor.

Proper selection of detection and electronic components provide suitable parameters for use. Suitable sensor system parameters include, for example, a one year operational lifetime; the capability to operate in a temperature range from about −40° F. to about 140° F.; and operability at ambient pressure, i.e. about 14.7 psi.

A prototype of a gas sensor in accordance with the present invention has been successfully tested. The prototype was constructed in an electronics “project” box purchased from a retail electronics store (Radio Shack, Catalogue number #270-283A), a molded enclosure with an aluminum lid that includes a general-purpose circuit board with standard DIP IC hole spacing. The illumination/photodetector/LED circuit was set-up on the breadboard. Several types of photodiodes and phototransistors have been tested including Darlington type phototransistors. Typically the phototransistor is surrounded by UV LED's that are used to illuminate the surface. In one example, holes were drilled in the end to attach tubing for gas flow and wiring. PtOEP in a silica gel/PDMS matrix was applied to the interior of the box as a thick coating. A central photodetector such as a TO-46 NPN Phototransistor (Mouser Electronics) or a S1227-1010BR Photodiode (Hamamatsu Corp.) was surrounded by 4-6 UV LED's such as W7113UVC 5 mm 395 nm UV LED (Kingbright Corp.). The indicator lights were simple LEDs, for example W53LID 5 mm Red Low Current LED (Kingbright Corp.). In air, the fluorescence of the PtOEP was fully quenched. When the air was evacuated from the box (nitrogen was used to purge the air rather than hydrogen), the paint emits light, the phototransistor detects this emission and sends a signal to the LED's. To strengthen the signal, it may be necessary to bias the indicator LED's so that they can be activated by a smaller signal. However, because the intensity of emitted light falls off as 1/r², size reduction may remove the need for biasing.

Another exemplary use of the present invention is in prototype testing, for example in wind tunnel testing in aeronautics. Traditional methods of wind tunnel testing for pressure changes on a surface do not use a sensor directly at the surface. Rather, holes in the surface are connected to tubes which are in turn connected to a pressure sensor for quantitative measurement. The system has drawbacks arising from the fact that the pressure at the surface is not directly measured. The use of tubes can create pressure differentials between the surface and the sensing device that must be taken into account. Also, there may be some small lag time between a pressure change at the surface and the detected pressure change. Further, small instantaneous variations in pressure may not be detected. These shortcomings can be overcome by use of a sensor according to the present invention. More particularly, a sensor according to the present invention can be mounted on a portion of a surface being tested. This would give a direct reading at the surface. Alternatively, the surface being tested can be coated with a coating that includes a sensing material, for example a pressure sensitive polymer. Fiber optics and/or circuitry can extend between a data recording device, such as a computer or other recording device, much as tubing is currently used for pressure sensing using existing techniques. Such a sensor would provide instantaneous readings directly at the surface being evaluated.

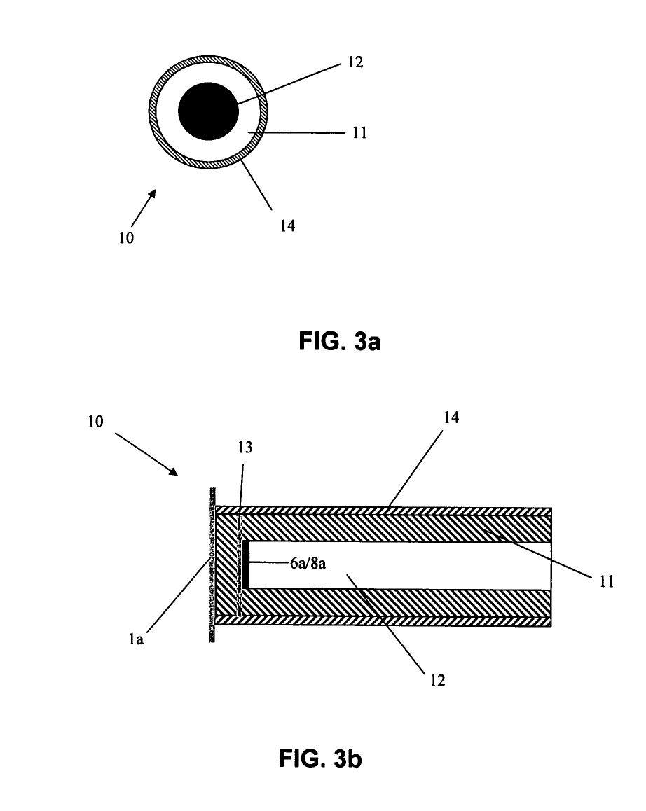

Rather than the tubes relaying air pressure directly, the tubes can be used to house a fiber optic system for use with a sensor according to the present invention. FIG. 3 illustrates an exemplary embodiment of a sensor 10 according to the invention that could be used for measuring pressure changes at the surface. The embodiment illustrated in FIG. 3 has the advantage of utilizing tubes 14 currently in use for pressure measuring instrumentation. According to this illustrated embodiment, a coaxial arrangement of components is present within the tubes 14, as shown in the end view diagram of FIG. 3a. An annular light guide or fiber optic 11 is in the exterior/annular position. Illumination from an illumination source propagates through the light guide to a surface 1a that includes a sensing material, as shown in FIG. 3b. As described above, the sensing material may be included in a coating on the surface. A central core 12 of the coaxial assembly can include a receiver 6a, such as a phototransistor, and/or detector 8a, and associated circuitry, at the end. Signals sensed at the receiver can be transmitted electronically through circuitry located in the core 12 of the coaxial assembly to the remaining circuitry, for output and analysis. Alternatively, the emitted light can be transmitted optically through the core 12 of the coaxial assembly, and the receiver, detector and other circuitry located remote from the surface. The illustrated assembly can include additional optical components 13, e.g. filters and lenses, at the end of the coaxial assembly, for example between the light guide 11 and receiver/detector 6a/8a and the surface being analyzed. Where emitted light is transmitted optically away from the surface, such as through a light guide in the core, it may be desirable for the additional optical components 13 to include an amplifier. As will be appreciated, the exact arrangement of optical and electronic elements can be varied in view of the present disclosure. The system described herein is only exemplary and is not limiting.

Persons skilled in the art will recognize other applications of this device for measuring temperature, pressure, atmosphere or other environmental conditions.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1) A sensor comprising:
a surface comprising a sensing material that is responsive to a change in an environmental condition when illuminated;
an illumination source positioned to illuminate the surface;
a receiver positioned to receive light emitted from the surface; and
a detector capable of detecting a change in light received at the receiver.

2) The sensor of claim 1, wherein the detector comprises a comparator

3) The sensor of claim 2, further comprising a variable reference voltage at the detector.

4) The sensor of claim 2, further comprising a positive feedback loop.

5) The sensor of claim 2, further comprising an indicator to indicate a change in light received at the receiver.

6) The sensor of claim 1, wherein the surface further comprises a coating and the coating comprises the sensing material.

7) The sensor of claim 1, wherein the environmental condition is selected from temperature, pressure and atmospheric composition.

8) The sensor of claim 1, wherein the change in environmental condition is a change in atmospheric oxygen content.

9) The sensor of claim 5, wherein the indicator comprises a colored light.

10) The sensor of claim 1, wherein an emission spectrum or intensity of the sensing material changes in response to the change in the environmental condition when illuminated.

11) The sensor of claim 1, wherein the sensing material comprises a dye in a polymer matrix.

12) The sensor of claim 1, wherein the sensing material comprises a dye incorporated into a polymer material.

13) The sensor of claim 1, wherein the sensing material comprises a polymer that comprises a pair detector compounds form a fluorescence resonance energy transfer pair or are capable of forming an exciplex.

14) The sensor of one of claims 11-13 wherein the polymer is selected from a polyurethane, a polyacrylate or a silicone.

15) A method for detecting a change in an environmental condition comprising:
illuminating a surface comprising a sensing material;
receiving the light emitted from the surface when the surface is illuminated;
detecting a change in the light emitted from the surface when the environmental condition changes; and
outputting a signal to an indicator; wherein
the light emitted from the sensing material when the surface is illuminated changes in response to a change in the environmental condition; and
the illuminating, receiving and detecting are carried out by an integrated system.

16) The method of claim 15, wherein the environmental condition is selected from temperature, pressure and atmospheric composition.

17) The method of claim 15, wherein the light emanating from the surface is a fluorescence.

18) The method of claim 15, wherein the sensing material comprises a dye in a polymer matrix.

19) The method of claim 15, wherein the sensing material comprises a dye incorporated into a polymer material.

20) The method of claim 15, wherein the sensing material comprises a polymer that comprises a pair detector compounds form a fluorescence resonance energy transfer pair or are capable of forming an exciplex.

21) The method of one of claims 18-20 wherein the polymer is selected from a polyurethane, a polyacrylate or a silicone.
